(19) United States
(12) Patent Application Publication
(10) Pub. No.: US 2021/0216405 A1
(43) Pub. Date: Jul. 15, 2021

(54) NETWORKING COMPONENT REPAIR

(71) Applicant: HEWLETT-PACKARD DEVELOPMENT COMPANY, L.P., Spring, TX (US)

(72) Inventors: I-Chen LIN, Taipei (CN); Han-Kuang CHANG, Taipei (CN); Yi-Ching LIN, Taipei (CN)

(73) Assignee: HEWLETT-PACKARD DEVELOPMENT COMPANY, L.P., Houston, TX (US)

(21) Appl. No.: 16/076,085

(22) PCT Filed: Jun. 29, 2017
(86) PCT No.: PCT/US2017/039969

§ 371 Date: Aug. 7, 2018

(51) Int. Cl. G06F 11/14; H04L 12/24

(52) U.S. Cl. CPC G06F 11/142; G06F 11/1417; G06F 2201/85; H04L 41/0863; H04L 41/0672

(57) ABSTRACT

Examples associated with networking component repair are described. One example includes detecting an error associated with a networking component of a device. The networking component may be disabled and enabled to attempt to remedy the error associated with the networking component. When the disabling and enabling actions fail to remedy the error and the error is associated with a driver for controlling the networking device, a setting associated with the networking component may be repaired. The networking component may be controlled to connect to a known available network using historical connection settings.

### BACKGROUND

To connect to the Internet and other networks, devices today such as laptops and mobile phones contain networking components specialized for the purpose of facilitating communication between devices both over wired connections and wirelessly. These networking components may include antennas, ports, circuitry, software, and so forth that implement various communication standards that allow devices to communicate one another. To control a networking component, a device may include various drivers, settings, and other data that is used to, for example, control connection of the networking component to specific other devices and/or networks, convert data between formats used by the networking component and applications on the device, and so forth.

### BRIEF DESCRIPTION OF THE DRAWINGS

The present application may be more fully appreciated in connection with the following detailed description taken in conjunction with the accompanying drawings.

FIG. 1 illustrates an example device associated with networking component repair.

FIG. 2 illustrates a flowchart of example operations associate with networking component repair.

FIG. 3 illustrates an example system associated with networking component repair.

FIG. 4 illustrates another example device associated with networking component repair.

FIG. 5 illustrates an example computing device in which example systems, and methods, and equivalents, may operate.

### DETAILED DESCRIPTION

Systems, methods, and equivalents associated with networking component repair are described. When a networking component of a device fails, that device may be unable to communicate with nearby and remote devices. Because accessing remote content, whether via a web browser or other application, is one of the most common uses for personal computers today, the failure of the networking component may significantly impinge on the utility of a device to its user. Consequently, customer support calls are often associated with an inactive networking component.

While an inactive component may sometimes be the result of a malicious actor (e.g., via a malware) or an accident caused by the user (e.g., dropping a device), sometimes the networking component may go inactive due to a legitimate application a user has downloaded and installed on the computer that has caused some change to the device. Consequently, to attempt to automatically fix certain types of networking component failures, an application may be embedded on devices to perform a series of actions to attempt to fix the networking component as soon as a failure is detected by the operating system. These actions may include, for example, rebooting the networking component, repairing drivers or other settings, and forcing the networking component to connect to a known, detected network using historical data. This may enhance user experience by reducing downtime of the networking component. Additionally, automatic recovery from certain failures may reduce resources expended on customer support by a distributer of a device containing the networking component.

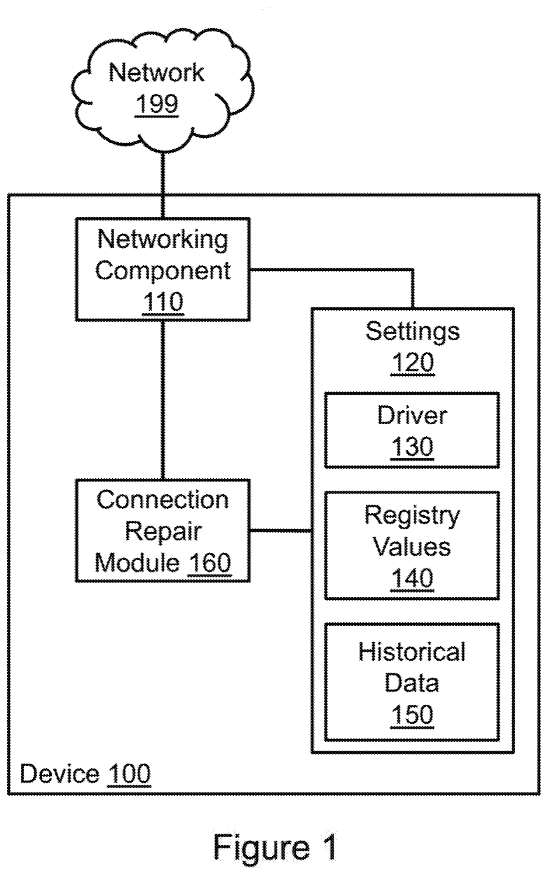

FIG. 1 illustrates an example device associated with networking component repair. It should be appreciated that the items depicted in FIG. 1 are illustrative examples, and many different systems, devices, and so forth, may operate in accordance with various examples.

FIG. 1 illustrates an example device 100 associated with networking component repair. Device 100 may be, for example, a desktop, a laptop, a mobile device, and so forth. Device 100 may include a networking component 110. Networking component 110 may be, for example, an internal or external network card of the device, and so forth. Networking component 110 may include ports, antennas, circuitry, and so forth that allows networking component 110 to facilitate communication between device 100 and other devices. In this example, networking component 110 is illustrated as connecting device 100 to network 199. Network 199 may be, for example, the Internet, a local area network, wireless network, a virtual private network, and so forth. In various examples, networking component 110 may connect device 100 to network 199 via other devices (e.g., a router, a modem).

To control networking component 110, device 100 may include a variety of settings 120. The settings may include a device driver 130, registry values 140, historical data 150, and so forth. Device driver 130 may be, for example, computer executable instructions that device 100 can use, for example, as an application programming interface for networking component 110, to facilitate translating data to and from a format used by networking component 110, and so forth. Registry values 140 may similarly aid device 100 in operating and/or controlling networking component 110. Historical data 150 may describe previously used network settings that networking component 110 has used to connect to networks in the past. Thus, in one example, historical data 150 may include login information for a variety of wireless networks that networking component 110 may be able to use to re-login to those wireless networks in the future without asking a user to re-input these credentials.

Device 100 also includes a connection repair module 160. Connection repair module 160 may be used by device 100 to automatically fix certain failures associated, with networking component 110. These failures may be detected, for example, based on events triggered by an operating system. By way of illustration, if an operating system of device 100 is unable to access a known network 199, a specific website, and so forth, the operating system 100 may indicate to a user that networking component 110 has failed in some manner and that the failure may need to be diagnosed and resolved to access remote resources.

When this indication is detected by connection repair module 160, connection repair module 160 may take a series of actions to attempt to remedy the failure of networking component 110 before directing the user to a customer support resource (e.g., a service hotline). For example, connection repair module 160 may reboot networking component a fixed number of times, attempt to repair settings 120 that may have recently been changed (e.g., by restoring driver 130 and/or registry values 140 to prior, known valid states), and/or attempt to force networking component to connect to a known, detected network 199 to which networking component 110 has connected to before (e.g., using historical date 150).

In the event that the actions taken by connection repair module 160 do not resolve the failure of networking component 110 and device 110 remains unable to access network 199, connection repair module 180 may then refer the user to a customer support resource. Additionally, connection repair module 160 may convey the specific actions taken by connection repair module 160 to the customer support resource. This may allow the customer support resource to skip asking the user to take the measures already taken by connection repair module 160.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

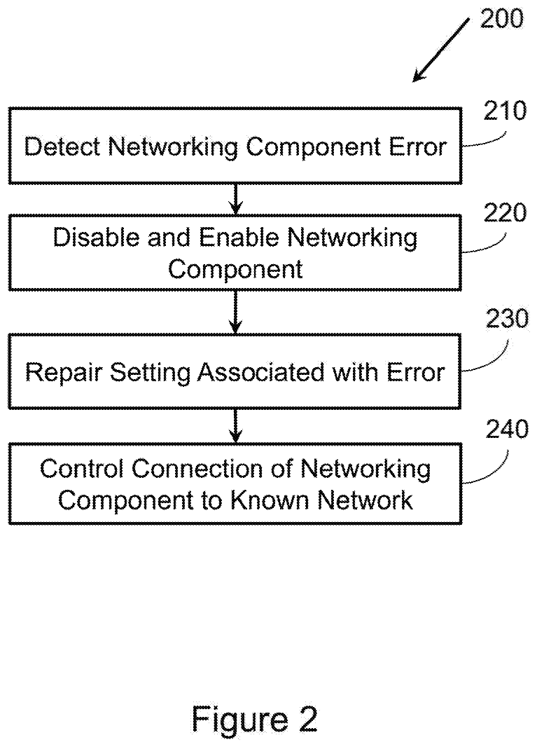

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with networking component repair. Method 200 may be performed by a device. The device may include a networking component. The networking component may be, for example, a networking card that includes connectors, chips, and so forth to allow the device to connect to and communicate with external networks and/or devices. Method 200 includes detecting an error associated with the networking component at 210. The error may be, for example, an inability of the device to connect to a known, available connection, network, remote location (e.g., webpage, specific server), and so forth. The error may be caused, for example, by a malicious entity, by a user executing an application that triggers a change to the device that prevents the networking component from connecting to a known available network, and so forth. The error associated with the networking component may be detected based on an event triggered by an operating system of the device.

Method 200 also includes disabling and enabling the networking component at 220. Disabling and enabling the networking component may remedy the error associated with the networking components. In some examples, the disabling and enabling actions may be repeated a specific number of times. This may ensure that the networking component has properly started and/or stopped, potentially giving the networking component a chance to automatically correct certain errors.

Method 200 also includes repairing a setting associated with the error at 230. The setting may be repaired when the disabling and enabling actions taken at 220 fail to remedy the error and when it appears that the error is associated with a driver for controlling the networking component. In one example, repairing the setting may involve restoring a registry value associated with the networking component to a prior, known valid state. In other examples, repairing the setting may involve reinstalling a driver for the networking component.

Method 200 also includes controlling connection of the networking component to a known, available network at 240. The connection may be established using historical connection settings. By way of illustration, the error detected at action 210 may be caused by the networking component not automatically connecting to the known, available network despite detecting the presence of the known, available network. Consequently, in this case, it may be possible to resolve the error by controlling initiation of a connection to the known available network using connection settings (e.g., username, password) that have previously used assuming the connection settings are still valid.

In some examples, if the error associated with the networking component remains unresolved, a user may be referred to a customer support resource. The customer support resource may be, for example, a telephone number at which the customer can obtain technical support, a web page, a manual or other technical resource installed on the device, and so forth. In examples where the device is able to communicate with the customer support resource (e.g., via the user), the device may convey support actions taken to the customer support resource. This may allow the customer support resource to skip asking the user to retake these actions.

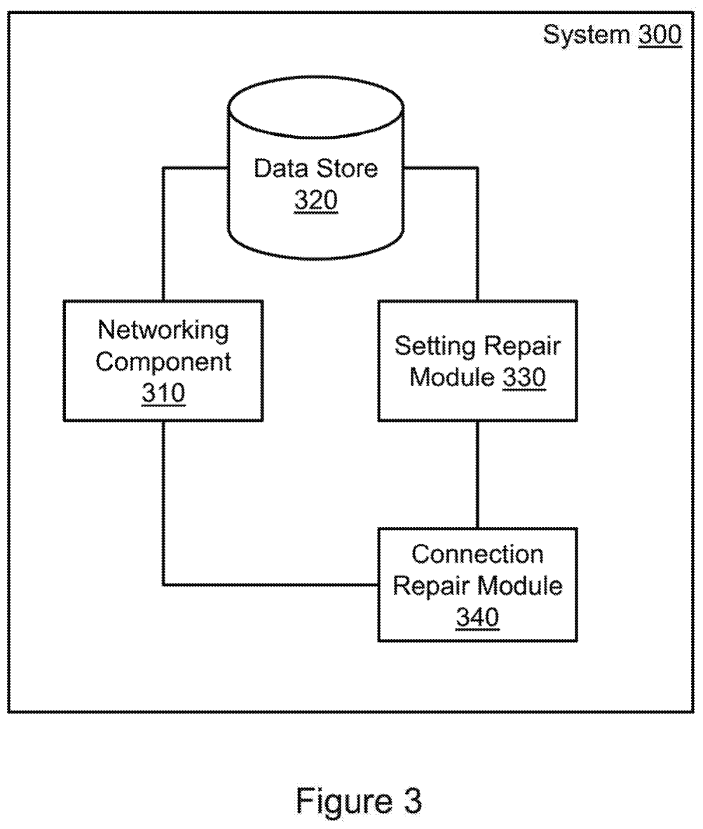

FIG. 3 illustrates a system 300 associated with networking component repair. System 300 includes a networking component 310. Networking component 310 may be, for example, a network card embedded in system 300. System 300 may be, for example, a desktop computer, a laptop, a mobile device, and so forth.

System 300 also includes a data tore 320. Data store 320 may store settings associated with the networking component. The settings may include, for example, a driver for the networking component, a registry value associated with the networking component, a historical record associated with a network to which the networking component has previously connected, and so forth.

System 300 also includes a setting repair module 330. Setting repair module 330 may restore a setting associated with networking component 310 to a known valid state. This may be achieved by, for example, restoring the setting from a backup stored within system 300, obtaining the setting from an external source, and so forth.

System 300 also includes a connection repair module 340. Connection repair module 340 may detect an error associated with networking, component 310 that renders networking component 310 unable to connect to a network. This error may be detected based on, for example, an event triggered by an operating system operating on system 300 that notices an inability to reach the Internet or some other known network. In various examples, the error may be caused by a malicious entity, a user executing an application that triggers a change to the settings in in data store 320, and so forth. Connection repair module 340 may then attempt to fix the error by rebooting networking component 310. When rebooting networking component 310 fails to fix the error, connection repair module 340 may initiate setting repair module 330 to attempt to fix the error.

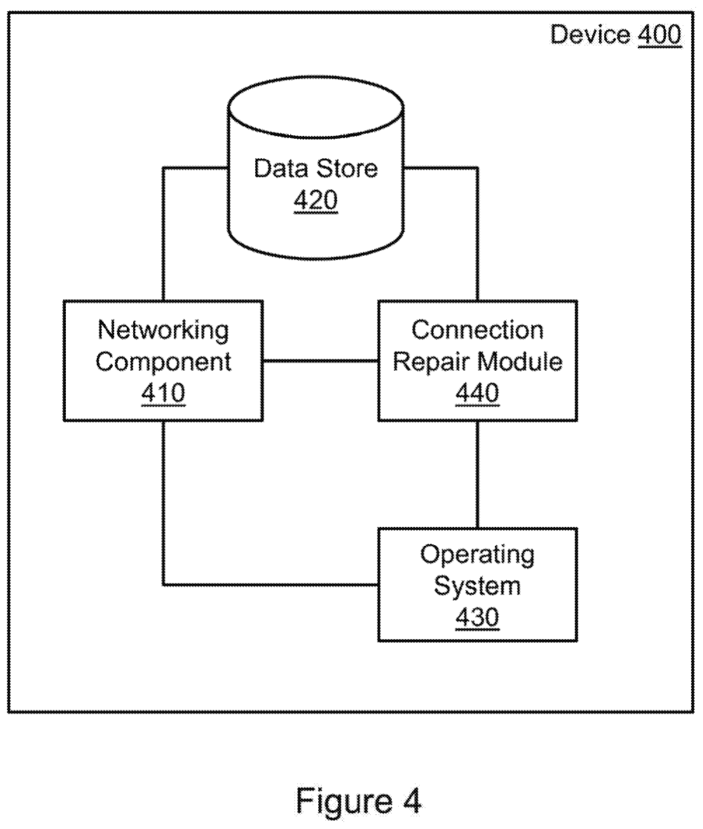

FIG. 4 illustrates an example device 400 associated with networking component repair. Device 400 includes a networking component 410. Device 400 also includes a data store 420. Data store 420 may store data associated with networking component 410. The data may include a driver for networking component 410, registry settings associated with networking component 410, historical records associated with networks to which networking component 410 has connected, and so forth.

Device 400 also includes an operating system 430. Operating system 430 may trigger an event when the operating system is unable to connect to a known network via networking component 410.

Device 400 also includes a connection repair module 440. Connection repair module 440 may take a series of actions in response to the event to resolve the inability of operating system 430 to connect to the known network. These actions may include, for example, rebooting networking component 410 a fixed number of times, restoring data in data store 420 to a known prior valid state, forcing networking component 410 to connect to an available network using a historical record associated with the available network. If these actions fail to resolve the inability of operating system 430 to connect to the known network, connection repair module 440 may refer a user to a customer support resource. Additionally, when referring the user to the customer support resource, connection repair module 440 may inform the customer support resource of actions taken by connection repair module 440.

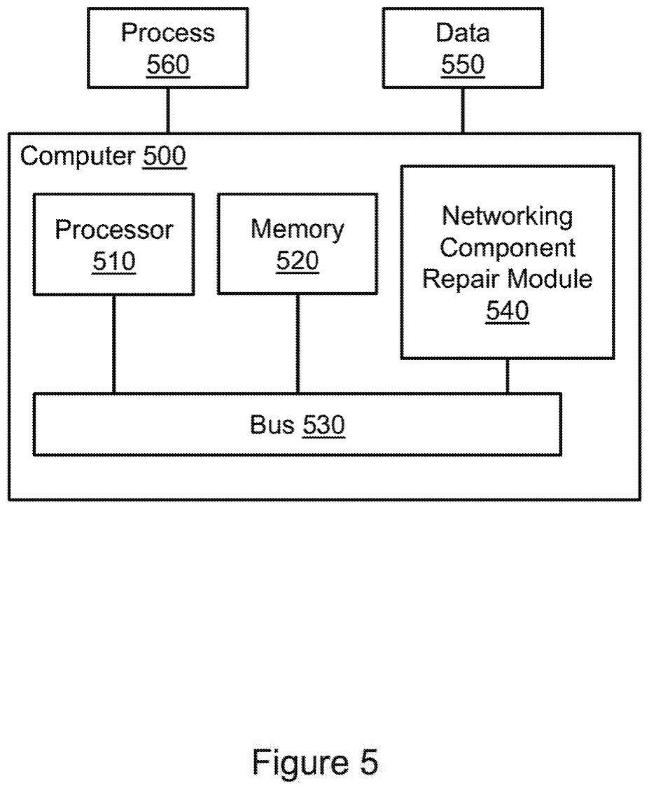

FIG. 5 illustrates an example computing device in which example systems and methods, and equivalents, may operate. The example computing device may be a computer 500 that includes a processor 510 and a memory 520 connected by a bus 530. Computer 500 includes a networking component repair module 540. Networking component repair module 540 may perform, alone or in combination, various functions described above with reference to the example systems, methods, and so forth. In different examples, networking component repair module 540 may be implemented as a non-transitory computer-readable medium storing processor-executable instructions, in hardware, software, firmware, an application specific integrated circuit, and/or combinations thereof.

The instructions may also be presented to computer 500 as data 550 and/or process 560 that are temporarily stored in memory 520 and then executed by processor 510. The processor 510 may be a variety of processors including dual microprocessor and other multi-processor architectures. Memory 520 may include non-volatile memory (e.g., read-only memory) and/or volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
detecting, by a device, an error associated with a networking component of the device;
disabling and enabling the networking component to attempt to remedy the error associated with the networking component;
when the disabling and enabling actions fail to remedy the error and the error is associated with a driver for controlling the networking component, repairing a setting associated with the networking component to attempt to remedy the error associated with the networking component; and
controlling connection of the networking component to a known, available network using historical connection settings.

2. The method of claim 1, where repairing the setting involves restoring a registry value associated with the networking component to a prior, known valid state.

3. The method of claim 1, where repairing the setting involves reinstalling a driver for the networking component.

4. The method of claim 1, where the error is an inability to connect to a known, available connection.

5. The method of claim 1, comprising referring a user to a customer support resource when actions taken fail to remedy the error associated with the networking component.

6. The method of claim 5, comprising conveying support actions taken to the customer support resource.

7. The method of claim 1, where the error is caused by a user executing an application that triggers a change to the device that prevents the networking component from connecting to the known, available network.

8. The method of claim 1, where the disabling and enabling actions are repeated a fixed number of times.

9. The method of claim 1, where the error associated with the networking component is detected based on event triggered by an operating system of the device.

10. A system, comprising:
a networking component;
a data store to store settings associated with the networking component;
a setting repair module to restore a setting associated with the networking component to a known valid state; and
a connection repair module to detect an error associated with the networking component rendering the networking component unable to connect to a network, to attempt to fix the error by rebooting the networking component, and to initiate the setting repair module when rebooting the network component fails to fix the error.

11. The system of claim 10, where the settings include one or more of, a driver for the networking component, a registry value associated with the networking component, and a historical record associated with a network to which the networking component has previously connected.

12. The system of claim 10, where the error is detected based on event triggered by an operating system noticing an inability to reach the Internet.

13. The system of claim 10, where the where the error is caused by executing an application that triggers a change to the settings that prevents the networking component from connecting to a known, available network.

14. A device, comprising:
a networking component;
a data store to store data associated with the networking component, the data including a driver for the networking component, registry settings associated with the networking component, and historical records associated with networks to which the networking component has connected;
an operating system to trigger an event when the operating system is unable to connect to a known network;
a connection repair module to, in response to the event, take a series of actions to resolve the inability of the operating system to connect to the known network, the series of actions comprising:
rebooting the networking component a fixed number of times;
restoring data in the data store to a known prior valid state; and
forcing the networking component to connect to an available network using a historical record associated with the available network.

15. The device of claim 14, where the connection repair module refers a user to a customer support resource when the series of actions fails to resolve the inability of the operating system to connect to the known network, and where the connection repair module informs the customer support resource of actions taken.
